(19) United States
(12) Patent Application Publication
(10) Pub. No.: US 2009/0317205 A1
(43) Pub. Date: Dec. 24, 2009

(54) Decking beam support bracket

(76) Inventors: Steven John Heng, Ashton, IL (US); David James Duke, Oregon, IL (US)

Correspondence Address: DAVID JAMES DUKE, 310 ALDRIN STREET, OREGON, IL, 61061, US

(21) Appl. No.: 12/387,295

(22) Filed: Apr. 30, 2009

Related U.S. Application Data
(60) Provisional application No. 61/132,990, filed on Jun. 24, 2008.
(60) Provisional application No. 61/135,517, filed on Jul. 21, 2008.

(51) Int. Cl. B60P 1/64

(52) U.S. Cl. 410/52

(57) ABSTRACT

A decking beam support bracket being removably attachable to vertical anchoring tracks installed in a cargo container. The decking beam support bracket comprises a durably rigid horizontal frame. Each end of the support bracket frame has inwardly tapered ends, whereby protecting cargo from the bracket during loading or unloading of the container. Various slots are formed into the length of the frame and spaced a short distance apart allowing a decking beam to be attached at varying intervals according to the length of the bracket. The bracket is attachable to the vertical anchoring tracks by having two securement members attached on the rear side of opposing ends of the bracket frame. A rail set and sliding mechanism for a single securement member is optionally employed on one end of the frame allowing the securement member to be horizontally adjustable for anchoring tracks being

### CROSS-REFERENCE TO RELATED APPLICATIONS

This application claims the benefits of provisional patent applications Ser. No. 61/132,990 and Ser. No. 61/135,517 filed Jul. 30, 2008 and Aug. 6, 2008 respectively by the present inventors.

### FEDERALLY SPONSORED RESEARCH

Not applicable

### SEQUENCE LISTING FOR PROGRAM

Not applicable

### FIELD OF INVENTION

The present invention relates to cargo securement and bracing, specifically for such cargo being transported in containers having vertical anchoring tracks.

### PRIOR ART

The process of transporting freight has many obstacles involved when shoring and securing freight. Because of the various sizes and weights of shipments, securing freight from damage and from causing injury to others is paramount in consideration of the transportation. Additionally, the safety of the freight itself must be considered in order for transportation companies to retain the confidence of their customers as well.

Another concern when securing freight from shifting during transport is the safety precautions placed on transportation companies from the Department of Transportation. Hazardous cargo shipments, according to the Department of Transportation code of federal regulations as read in title 49 part 177.834a, must be secured in a way that prevents the cargo from shifting or moving in route.

With these safety concerns in mind, transportation companies are constantly concerned about utilizing the maximum amount of space available to them in their containers. Stacking freight as high as possible, or cubing out, is the primary way a company is able to use all space available. The cubing of a trailer along with the safety concerns of freight and individuals have caused many changes in the way trailers are designed.

Many trailer manufacturing companies are designing trailers having a vertical or horizontal track system incorporated into the side walls of the trailer. This track system allows for a decking beam to be placed between each side wall and allow for decking of cargo.

Along with allowing freight to be decked on top of the beams, the decking beams are commonly used to block freight from moving forward or rearward in transit.

Trailers having horizontal anchoring tracks, mounted on opposing walls, allow a decking beam to be used to secure freight from shifting or tipping forward or rearward. This design works quite effectively for securing freight from jolting forward or rearward because of the close frequency of the anchoring slots in each track.

However, the horizontal anchoring tracks restrict a trailer from having many options for the height of decking freight. Commonly, a trailer with horizontal decking tracks has only two or three track heights for decking. This scenario causes complications with transportation companies hauling various heights and weights of freight. The decking options are extremely limited but the freight securement options are vast.

Trailers incorporating a group of vertical anchoring tracks restrict a decking beams freight bracing capabilities based on the spacing distance between each vertical track. Commonly, a vertically tracked anchoring system has spacing between tracks of sixteen to twenty-four inches and being spaced from the rear of the trailer to the front. One of the reasons for this interval of spacing is to allow for easier decking of common pallet sizes.

The decking beams, in conjunction with vertical anchoring tracks, have been designed with the intent of decking freight more effectively, not for securing cargo from shifting forward or rearward. If a pallet of freight is loaded, and extends only inches from one of the vertical tracks, the next decking beam, used for bracing, would not be tight against the freight. Therefore, the decking beam is not able to adequately secure the freight from shifting. Many situations arise where a decking beam could be twenty-three inches or more away from the freight the decking beam is intended to secure. However, a decking beam is still used to attempt the securement of freight, even if the decking beam is not secured against the shipment.

Additionally, not all containers are designed with the same specifications. The track spacing frequently differs for each transportation company.

A common problem therefore exists when trying to cube out a trailer and when trying to secure freight during transport. A company is forced to decide between a track system designed primarily for decking freight or for securing freight.

Typically, jack bars or cargo securement straps are used to secure freight from shifting during transit.

The problem with having a jack bar, such as the one described in U.S. Pat. No. 5,979,876 to Cardona (1999), used in conjunction with decking beams is having the hassle of dealing with multiple types of securement and loading items throughout the trailer. Additionally, a sudden powerful stop by the tractor-trailer could cause the freight to jolt forward, causing the jack bar to slip. If the jack bar slips forward, the freight is no longer braced in place and can easily tip. Additionally, a jack bar has rubber pads on each end of the bar. After time, the rubber begins to harden causing the bar to slip more easily. Also, the jack bar works independently of the vertical tracking installed. This does not allow the benefit of the solid anchoring slots employed by the tracks.

Securement straps are typically used for securing freight to the trailer side wall. The straps prevent freight from tipping over sideways but are not well suited for preventing the shipment from swaying forward or rearward. In addition, tightening the straps too much can cause damage to the freight. If the strap is not tightened enough, the freight becomes unstable and can easily tip. Securement straps also become tangled inside of the buckle assembly causing the user wasted time and money while securing the load.

The device of the present invention overcomes the above problems of load securement by allowing a user to tighten freight more securely, using a decking beam, without causing any damage to the cargo being transported. Additionally, the decking beam support bracket will allow a user more spatial options, utilizing current anchoring tracks, for load securement.

### Objects and Advantages

Accordingly, several objects and advantages of the present invention are:
a) to provide a cargo securement device durable enough to handle the rigors of freight being pressed against it during harsh unpredictable stops;
b) to provide a device allowing a decking beam to be positioned at closer intervals throughout a cargo container having a vertical anchoring track system installed, whereby allowing more options for cargo securement;
c) to provide a light weight load securement device easily adjustable for all users regardless of personal strength;
d) to provide a device allowing the transport of hazardous cargo to be secured tighter and in accordance with Department of Transportation regulations, without causing damage to the cargo;
e) to provide a device easily storable and modest while not in use; and
f) to provide a cargo securement device that compliments existing securement tools.

Further objects and advantages will become apparent by the ensuing description.

### SUMMARY

In accordance with the present invention, a decking beam support bracket comprises a rigid elongated member having multiple support slots horizontally spaced, inwardly tapered ends, a handle and two or more bracket securement members spaced on the back side.

### DRAWINGS—FIGURES

FIG. 1 shows a frontal perspective view of a decking beam support bracket.

FIG. 2 shows a rear perspective view of an adjustable decking beam support bracket.

FIG. 3 shows a sectional rear perspective view of an adjustable decking beam support bracket.

FIG. 4 shows a perspective view of a slide and securement member.

FIG. 5 shows a rear perspective view of an alternative decking beam support bracket.

FIG. 6 shows a frontal perspective view of an alternative decking beam support bracket.

FIG. 7 shows a decking beam support bracket supporting a decking beam in a cargo container.

### DRAWINGS—REFERENCE NUMERALS

101 Decking beam support bracket
101a Anchoring slot
102 Securement member
103 Slide
104a Upper slide rail
104b Lower slide rail
105 Stopper
106 Handle
107 Container wall
108 Vertical track
108a Vertical track anchoring slot
109 Decking beam
110 Cargo

### DETAILED DESCRIPTION—PREFERRED EMBODIMENT

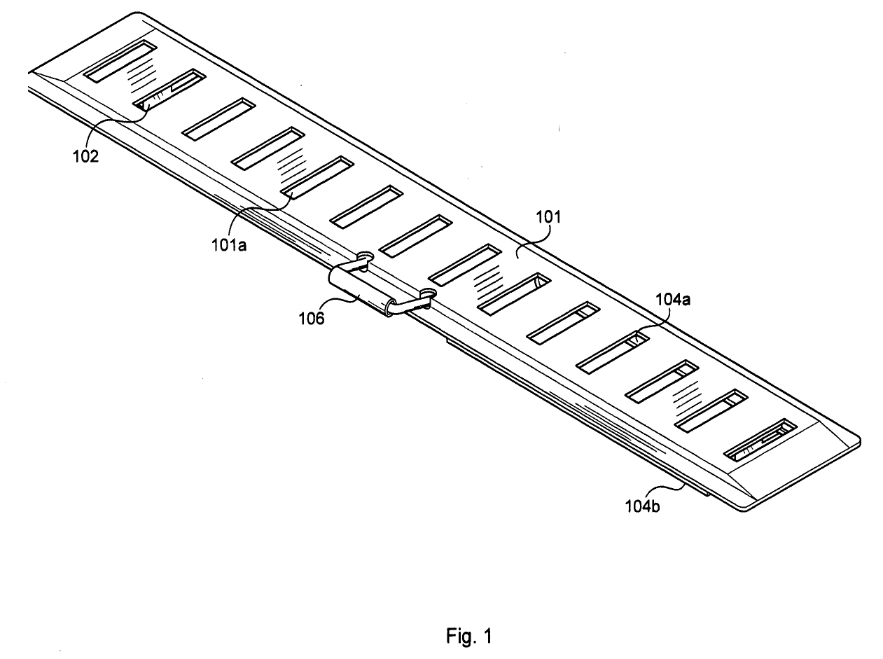

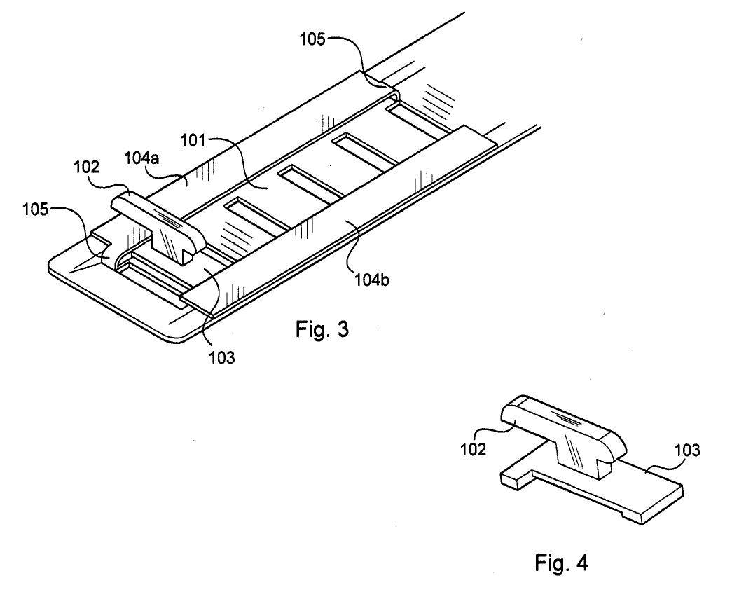

Referring now to FIGS. 1, 2, 3 and 4 there is seen a preferred embodiment of the rear side of a decking beam support bracket 101 having a securement member 102 mounted on a slide 103 whereby allowing the securement member 102 to become adjustable. Anchoring slots 101a are spaced throughout the length of the decking beam support bracket 101. The slots 101a are formed to allow a decking beam 109 to be secured when mounted between container walls 107 to secure cargo 110. A single securement member 102, formed to fit inside of a vertical track anchoring slot 108a of a vertical track 108 attached to a container wall 107, is permanently attached near one end of the decking beam support bracket 101. Additionally, the securement member 102 is attached between two separate bracket anchoring slots 101a, whereby allowing every slot to be used by a decking beam 109.

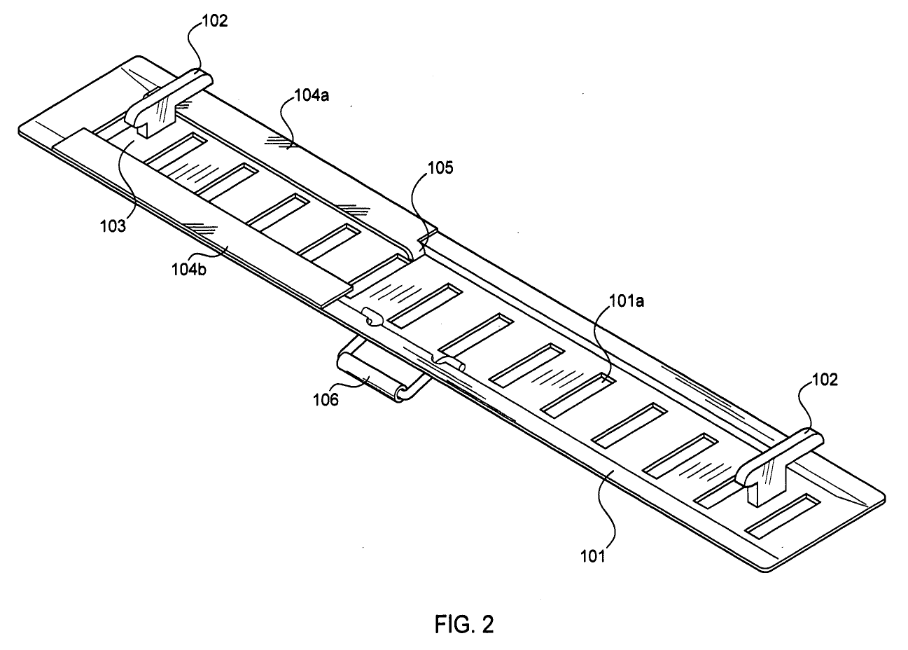

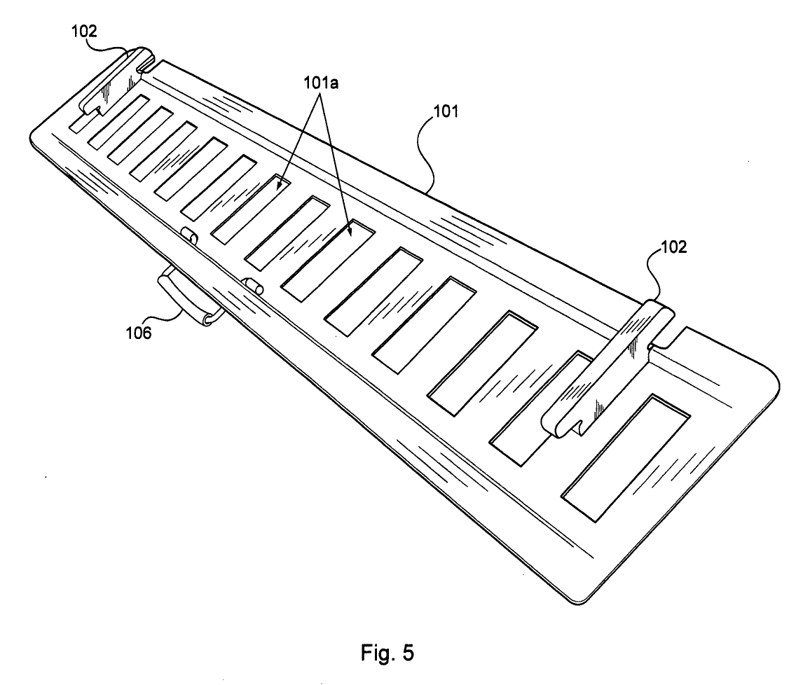

The opposite end of the support bracket 101 seats a slide 103, formed similar to a “T”, as seen in FIGS. 2 and 4. A securement member 102 is mounted to the slide 103 in the same direction as the permanent securement member 102.

On the same end of the support bracket 101 as the slide 103, an upper slide rail 104a and lower slide rail 104b is mounted respectively on the rear side above and below the anchoring slots 101a. The upper rail 104a has a stopper 105 for the securement member 102 mounted to the slide 103 when they are being adjusted.

Each end of the support bracket 101 is slightly tapered inward allowing cargo to be loaded without damaged caused by the support bracket 101. Additionally, a handle 106 is mounted on the bottom portion near the middle of the bracket, whereby allowing easy maneuvering of the bracket 101 during installation and removal.

### Operation—Preferred Embodiment

In operation, one uses a decking beam support bracket by:
1. With a decking beam support bracket 101 held by the handle 106, a user will ensure the bracket 101 is held horizontally and positioned between two vertical anchoring tracks 108, having been previously mounted to inside walls 107 of a freight container.
2. With the permanently attached securement member 102 positioned over a vertical track anchoring slot 108a, adjust the slide 103 left or right until aligned over a vertical track anchoring slot 108a of another vertical track 108.
3. With the fixed securement member 102 and the securement member 102 mounted to the slide 103 aligned to corresponding anchoring slots 108a of two separate vertical tracks 108, tip the bracket 101 upward allowing the top portion of the securement members 102 to slip into the vertical track anchoring slots 108a of both vertical tracks 108.
4. With the decking beam support bracket 101 still in hand, push upward and inward until the bottom portion of the securement members 102 are inside of the anchoring slots 108a of the vertical tracks 108.
5. Once both ends of securement members 102 are inside of the anchoring slots 108a, allow the bracket 101 to slide downward and seat in place.
6. A second bracket 101 will be secured to the opposing tracks 108 on the opposite wall 107 in registry with the first bracket 101 installed.

A user may now place a decking beam 109 into corresponding bracket anchoring slots 101a of the decking beam support brackets 101.

Removal of the decking beam support bracket 101 is done in opposite order as installation.
1. Remove any decking beams 109 from the decking beam support brackets 101.
2. Grasp the handle 106 in the middle of the bracket 101 and lift upward.
3. When the bracket 101 will not lift any higher, pull the lower portion of the bracket 101, with the lower portion of the securement members 102, out and away from the vertical track 108.
4. Lower the upper portion of the securement members 102 out of the anchoring track slots 108a.

Once the adjustable decking beam support bracket 101 has been removed, a user may place the bracket 101 in the same manner as described above anywhere in the container having anchoring tracks 108 installed.

Storage of the adjustable decking beam support bracket 101 can be on the floor of the container, out of the way of cargo, or in the vertical track anchoring slots 108a of the container. Gravity will allow the decking beam support bracket 101 to be held in place while the container is moving. The weight of a decking beam 109 is not necessary to hold the support bracket 101 in place.

### DETAILED DESCRIPTION—ALTERNATIVE EMBODIMENT

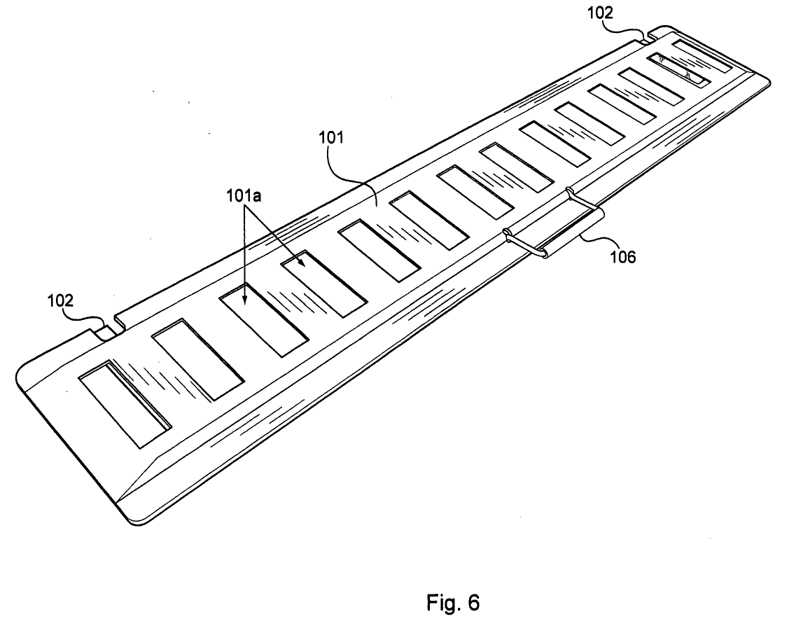

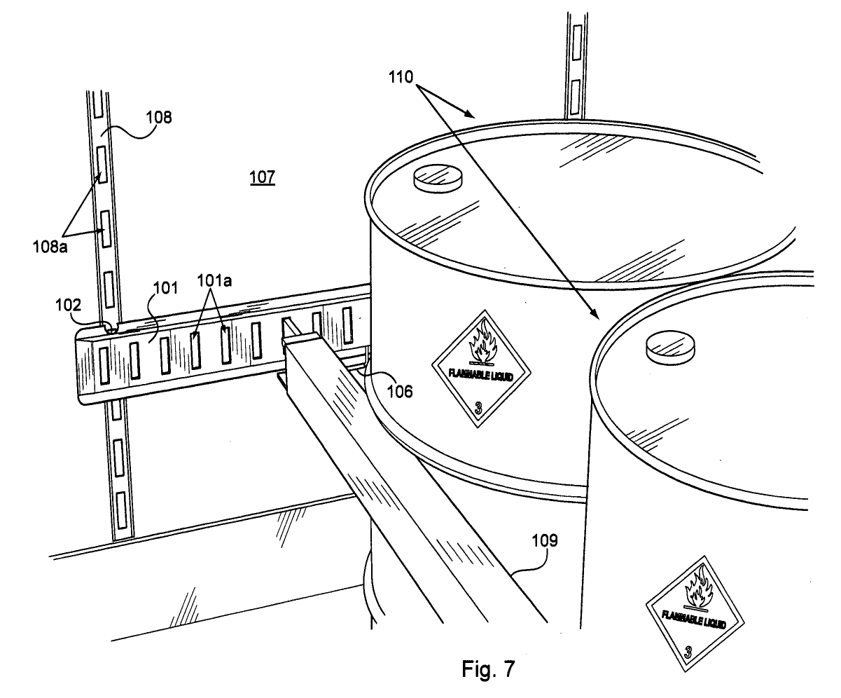

Referring now to FIGS. 5 and 6 there is seen an alternative embodiment of the rear and front side, respectively, of a decking beam support bracket 101. The decking beam support bracket 101 has two securement members 102 attached near opposite ends of the back side of a bracket 101, between support bracket anchoring slots 101a as seen in FIG. 5. The securement members 102 are spaced a predetermined length apart according to the spacing of the vertical anchoring tracks 108 mounted on a container wall 107.

Bracket anchoring slots 101a are spaced throughout the length of the decking beam support bracket 101. The slots 101a are formed to allow a decking beam 109 to be secured between two decking beam support brackets 101 mounted in registry on opposing walls 107.

Each end of the support bracket 101 is slightly tapered inward allowing cargo to be loaded without damaged caused by the support bracket 101. Additionally, a handle 106 is mounted on the bottom portion near the middle of the bracket, whereby allowing easy maneuvering of the bracket 101 during installation and removal.

### Operation—Alternative Embodiment

In operation, one uses the decking beam support bracket by:
1. With a decking beam support bracket 101 held by the handle 106, a user will ensure the support bracket 101 is held horizontally and positioned between two vertical anchoring tracks 108, having been previously mounted to the inside walls 107 of a freight container.
2. With the securement members 102 of the decking beam support bracket 101 aligned to corresponding anchoring slots 108a in two separate vertical tracks 108, tip the bottom of the support bracket 101 upward allowing the top portion of the securement members 102 to slip into the vertical track anchoring slots 108a of the vertical tracks 108.
3. With the decking beam support bracket 101 still in hand, push upward and inward until the bottom portion of the securement members 102 are inside of the vertical track anchoring slots 108a.
4. Once both ends of the securement members 102 are inside of the vertical track anchoring slots 108a, allow the bracket 101 to slide downward and seat in place.
5. A second bracket 101 will be secured to the opposing vertical tracks 108 on the opposite wall 107 in registry with the first bracket 101 installed.

A user may now place a decking beam 109 into corresponding bracket anchoring slots 101a of the decking beam support brackets 101.

Removal of the decking beam support bracket 101 is done in opposite order as installation.
1. Remove any decking beams 109 from the decking beam support brackets 101.
2. Grasp the handle 106 in the middle of the bracket 101 and lift upward.
3. When the bracket 101 will not lift any higher, pull the lower portion of the bracket 101, with the lower portion of the securement members 102, out and away from the vertical track 108.
4. Lower the upper portion of the securement members 102 out of the anchoring track slots 108a.

Once the adjustable decking beam support bracket 101 has been removed, a user may place the bracket 101 in the same manner as described above anywhere in the container having anchoring tracks 108 installed.

Storage of the adjustable decking beam support bracket 101 can be on the floor of the container, out of the way of cargo, or in the vertical track anchoring slots 108a of the container. Gravity will allow the decking beam support bracket 101 to be held in place while the container is moving. The weight of a decking beam 109 is not necessary to hold the support bracket 101 in place.

### Advantages

From the description above, a number of advantages of the decking beam support bracket are evident:
a) Current cargo containers having vertical track systems installed will be able to employ the present invention with more freight securing options.
b) Employing decking beam support brackets will not require any design changes to current containers using a vertical track anchoring system.
c) The horizontal design of the decking beam support bracket allows for simple storability away from users entering the container.
d) Transportation companies will be able to take advantage of more space in their vertically tracked containers because of the horizontal securement options available with the decking beam support bracket.

### Conclusion, Ramifications, and Scope

Accordingly, the reader will see the decking beam support bracket will be used in conjunction with current vertical anchoring tracks mounted to the sides of a cargo container, primarily semi trailers. In addition, the decking beam bracket allows a user to utilize a decking or shoring beam to be used in every available space, within the area of the vertical anchoring track mounting, for load securement. Whereas, currently a decking or shoring beam is restricted for load securement to only the space available by the vertical anchoring tracks. The decking beam support bracket fills the gaps between each vertical anchoring track.

Additionally, having one end of the bracket adjustable allows a company to use a single style of product for varying containers having different spacing of vertical tracks.

While the invention has been illustrated and described in detail, the invention is in no way to be limited by the examples provided. Thus the scope of the invention should be determined by the appended claims and their legal equivalents.

We claim:

1. A removable decking beam support bracket attachable to multiple anchoring tracks of a cargo container comprising;
a) a rigid horizontal member having a multiplicity of slots formed therein and;
b) a plurality of securement members being positioned a predetermined distance apart.

2. A decking beam support bracket according to claim 1, wherein said anchoring tracks being vertically affixed in registry on opposing walls.

3. A decking beam support bracket according to claim 1, wherein said anchoring tracks having a multiplicity of elongated slots vertically formed therein.

4. A decking beam support bracket according to claim 1, wherein said slots being spaced a predetermined distance from each other.

5. A decking beam support bracket according to claim 1, wherein one of said securement members being horizontally adjustable.

6. A decking beam support bracket according to claim 1, wherein each end of said beam being tapered inward, whereby protecting cargo during loading and unloading.

7. A decking beam support bracket removably attachable to a multitude of vertical anchoring tracks, said anchoring tracks heretofore being installed in registry on opposing walls of a cargo container comprising;
a) a rigid horizontal member having a multiplicity of slots, horizontally spaced a predetermined distance each other, formed therein and;
b) A plurality of securement members being positioned near opposing ends of said bracket,
whereby allowing said horizontal bracket to be attachable to multiple said vertical anchoring tracks on the same said wall of said container.

8. A decking beam support bracket according to claim 7, wherein each end of said bracket being inwardly tapered, whereby protecting cargo from being damaged during loading or unloading of said container.

9. A method of securing cargo in a container heretofore having vertical anchoring tracks installed in registry on opposing walls comprising;
a) providing a bracket of the type comprising a rigid horizontal frame, a multitude of horizontally spaced slots formed therein, and multiple securement members positioned on rear side near opposing ends of said frame,
b) providing two said brackets each positioned in registry on said anchoring tracks on said opposing walls,
c) providing a decking beam and inserting each end into one said slot of said bracket on opposing said walls,
whereby said decking beam can be horizontally spaced between said vertical anchoring tracks of said container.

10. A method of claim 8 wherein said vertical anchoring tracks having slots vertically spaced a predetermined distanced from each other.
